(19) United States
(12) Patent Application Publication
(10) Pub. No.: US 2009/0212097 A1
(43) Pub. Date: Aug. 27, 2009

(54) Nested Storage Box And Retrofit For Hanging File Folders

(75) Inventors: Ellen Fredrich, Woodbury, MN (US); Pam L. Tidona, Northfield, MN (US)

Correspondence Address: Altera Law Group, LLC, 220 S 6 St Suite 1700, Minneapolis, MN, 55402, US

(73) Assignee: Smead Manufacturing Company

(21) Appl. No.: 12/436,581

(22) Filed: May 6, 2009

Related U.S. Application Data
(63) Continuation of application No. 11/360,068, filed on Feb. 22, 2006.
(60) Provisional application No. 60/655,560, filed on Feb. 23, 2005.

(51) Int. Cl. B42F 15/00; B65D 5/44; B65D 5/20

(52) U.S. Cl. 229/120.01; 229/199; 229/188; 493/56; 493/89

(57) ABSTRACT

A storage box for hanging file folders, which has an outer carton and an inner carton. The inner carton has a pair of removable reinforcing strips, which attach to opposing upper edges of the inner carton. Each hanging file folder is suspended by a pair of hangers that engage the reinforcing strips. The outer carton extends above the level of the file folders and their hangers, in order to engage a removable lid without interference from the hangers, the hanging file folders, or any index tabs that may be attached to the file holders. Optionally, the outer carton may have one or more handles.

### CROSS-REFERENCE TO RELATED APPLICATIONS

The present application claims the benefit of U.S. Provisional Application Ser. No. 60/655560 filed on 23 Feb. 2005, the complete subject matter of which is hereby incorporated herein by reference in its entirety.

### STATEMENT REGARDING FEDERALLY SPONSORED RESEARCH OR DEVELOPMENT

Not Applicable

### FIELD OF THE INVENTION

The present invention is directed to boxes, and more particularly to boxes for storage of hanging file folders.

### BACKGROUND

In an office environment, it is common to store hanging file folders in portable boxes. These boxes are less expensive than permanent file cabinets, and are well-suited for transporting and storing the hanging files.

Using a plain box, in which the hangers from the file folders rest on the upper edges of two opposing sides of the plain box, has several drawbacks. First, it becomes difficult to put a lid on the plain box, because the lid rests on the hangers from the file folders, rather than on the upper edges of the box. The external dimensions of the hangers tend to be slightly larger than the width of the box, so that a lid that normally fits the box has to stretch to fit over the hangers. The lid will ultimately be damaged (scored) by the hooks. Second, the hangers themselves may cause damage to the upper edges of the storage box. The hooks extending off the edge of the hangers apply a very concentrated force which crushes the edge of the box. Considering that the contact point is perhaps 2-3 square mm, the force on the box in psi (kg/sq m) is quite high. For instance, a particularly heavy hanging file folder may cut into the upper edges of the box and cause buckling or deformation to the edge. Furthermore, these hooks are sharp. A deformed or damaged edge may in turn snag the hangers, which may impede browsing through the hanging files.

A further problem is that many storage boxes exist already and it would be helpful to be able to retrofit existing boxes so that they are not damaged. A further problem is that it is helpful if the improvement is self supporting so that it does not take both hands to hold the file box and insert files.

Accordingly, there exists a need for a storage box with improved resistance to damage from the hangers on the hanging file folders. The storage box should accommodate a fitted lid without interference from the hangers, and should efficiently use the space inside the box and be easy to construct. Of course a primary objective is cost reduction and simplicity of set up. Many prior art devices have a failed because of their complexity, inability to retrofit existing boxes or cost of materials or constructions. The present invention addresses these issues.

### BRIEF SUMMARY OF THE INVENTION

This summary is provided to assist the reader in understanding some of the features of the invention and is not intended to define the scope thereof or even identify all of the embodiments. Reference should be had to the claims and the entire specification.

According to one aspect of the invention there is disclosed a support insert for a file box used for hanging folders having end hooks having a first and second pairs of opposing sidewalls formed at fold lines to create a self supporting box shaped perimeter of sidewalls, each sidewall having an upper edge and an outer surface, said insert being sized to be received within the inner dimension of the file box; at least one of said sidewall pairs including at least one integral spacer tab extending outwardly therefrom toward the inner surface of the file box, and when inserted therein creating a spacing gap between the inner surface of the file box and the outer extent of the insert, said gap being large enough to accommodate file folder end hooks supported by said upper edge but without providing support from said file box.

According to another aspect of the invention, there is disclosed, a file box for supporting hanging folders having end hooks having an outer box having four sides and a bottom and inner surfaces to said sides; an insert sized to be received within said outer box; including first and second pairs of opposing sidewalls formed at fold lines to create a self supporting box shaped perimeter of sidewalls, each sidewall having an upper edge and an outer surface, said insert being sized to be received within the file box; said sidewall pairs each including at least one integral spacer tab extending outwardly therefrom toward the inner surface of the file box, and when inserted therein creating a spacing gap between the inner surface of the file box and the outer extent of the insert at each file box sidewall, said gap being large enough to accommodate file folder end hooks, so that hanging files may be supported from either pair of insert sidewalls but without the hooks being supported by said outer box.

According to a further aspect of the invention there is a disclosed a method of constructing a self supporting file box insert, for an outer file box, with an integral spacer tab to prevent hanging file hooks suspended from said insert from being supported by the outer file box, comprising the steps of cutting a sheet into a rectangular shape; identifying fold lines at points along one extent to create adjacent panels; cutting tab shapes into said adjacent panels at said fold lines to create extensions out of an adjacent panel; folding the panels at the fold lines without folding the tabs, and connecting first and last panels for form a self supporting rectangular column.

### BRIEF DESCRIPTION OF THE SEVERAL VIEWS OF THE DRAWINGS

FIG. 1 is a perspective drawing of an assembled hanging file storage box with its lid removed.

FIG. 2 is an exploded view of a hanging file storage box.

FIG. 3 is a plan view of the inner carton folded flat.

FIG. 4 is an oblique view of a protective rail.

### DETAILED DESCRIPTION OF THE INVENTION

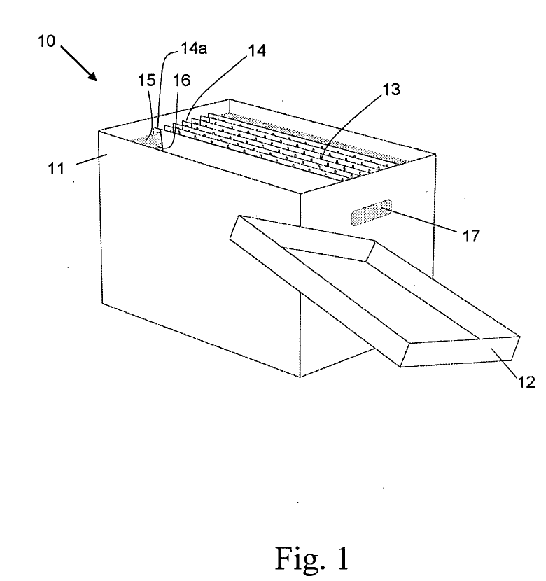

FIG. 1 shows an exemplary storage box 10 for hanging file folders. The box 10 has an outer carton 11 and an inner carton 16. The inner carton 16 has a pair of removable substantially non-deformable reinforcing strips/edge covers 15, which attach to opposing upper edges of the inner carton 16. Each hanging file folder 13 is suspended by a pair of hangers 14 with hooks 14a that engage the reinforcing strips 15. The outer carton 11 may extend above the level of the file folders 13 and their hangers 14, in order to engage a removable lid 12 without interference from the hangers 14, the hanging file folders 13, or any index tabs that may be attached to the file holders 13 (not shown). Optionally, the outer carton 11 may have one or more handles 17. Since this invention may be practiced also as a retrofit, outer carton 11 may be of varies types and construction.

The outer carton 11 and inner carton 16 are both preferably made from a cardboard material, with optional colorings or decorations. The outer carton may be of any design which is preferably constructed for a flat blank, though this is not essential. Both are preferably shipped flat to the customer, who folds them into the rectangular shape of FIG. 1. The customer then inserts the inner carton 16 into the outer carton 11, and applies the reinforcing strips 15 to opposing upper edges of the inner carton 16. Alternatively, the reinforcing strips 15 may be applied before the inner carton 16 is inserted into the outer carton 11. As a further alternative, the reinforcing strips 15 may be pre-attached before delivery to the customer, or may even be made integral with the inner carton 16, or the cardboard may be made rigid by many means such as plastic or resin injection, resin dipping or another hardening technique.

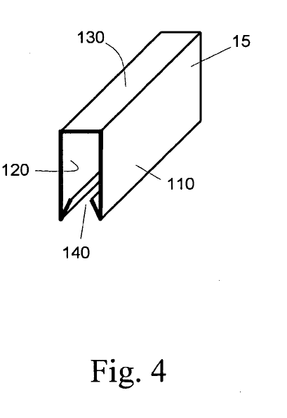

Also, the reinforcing strips 15 may be made from any suitably hard material, such as plastic, metal, or cardboard capable of preventing damage to the underlying softer cardboard construction of the inner box sidewalls. Preferably, each reinforcing strip is in the form of a longitudinal clip, which extends over the top and on opposite sides of the upper edge of the inner carton 16. Preferably the clip has two sidewalls 110, 120 and a bridging top member 130 capable of supporting hook ends of hanging files. The sidewalls 110, 120 with the top 130 define a space for the box side and preferably the sidewalls should be biased inward for a tight fit. Although the clip is drawn in FIG. 4 as largely rectangular, the sidewalls 110, 120 or top 130 may optionally have some curvature. To maintain strip 15 in place on the sidewall of the inner box, a pair of resilient gripping means 140 are provided in the form of teeth or barbs which extend upwardly toward the top 130 an at angle. When strip 15 is engaged on the sidewall of the inner box, barbs 140 flex to allow insertion, but resist removal by engaging the softer sidewall of the box by penetrating or deforming the sidewall on attempted removal. This can be important because the hooks 14a may snag the strip on withdrawal of a file.

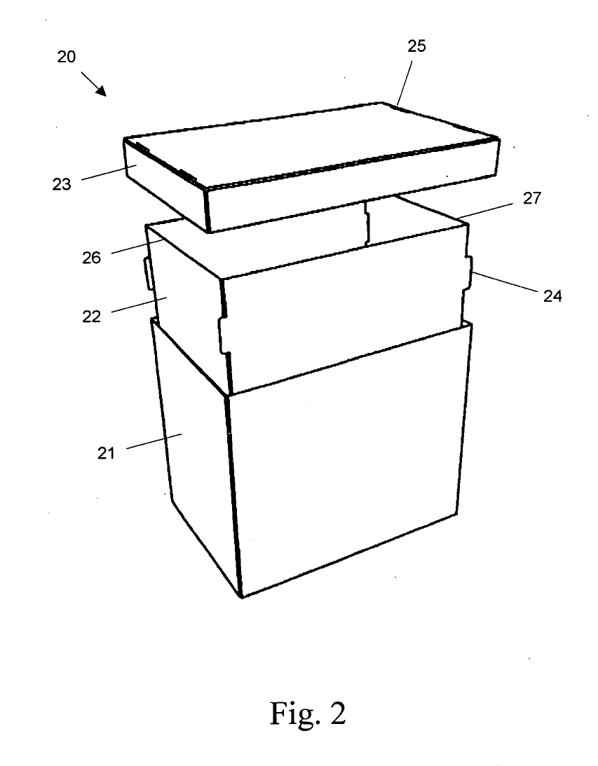

FIG. 2 is an exploded view of a second embodiment of a storage box 20 for hanging file folders. An inner carton 22 fits inside an outer carton 21, and is spaced apart from the outer carton 21 by a series of fold tabs or spacers 24. The fold tabs/spacers 24 ensure that the two cartons fit together snugly, but are spaced apart by a prescribed distance, generally enough to allow for the hooks of the hanging folders. Tab/spacers 24 are cut into adjacent panels along their fold lines 124. The separation between the two cartons is governed by the size of the fold tabs 24, and may be up to roughly 3 cm, preferably around 1 cm or just greater than, or equal to, the extend the hook overhangs the insert wall. In the preferred embodiment the hooks never touch (and damage) the outer box, but the space gap is small enough that the outer box can be the minimum possible dimension, for space saving reasons. Making this gap tight also increases the rigidity and self supporting feature of the insert.

This separation ensures that the hanger hooks 14a remain separated from the outer carton 21 during storage, but does not waste a significant amount of space inside the box 20. Note that the reinforcing strips (not shown in this figure) are placed on opposing edges 26 and 27 of the inner carton 22. Spacer tabs 24 also provide reinforcement between the inner and outer boxes. The outer box is sufficiently rigid but the inner (and sometimes retrofit) box is not particularly stable as it only has sidewall. The spaces 24 are best made as narrow as possible to that the two boxes next together as tightly as possible but sufficiently spaces so that the hooks do not normally engage the outer box.

A lid 23 fits onto the outer carton 21, which extends above the inner carton 22 far enough to clear the top of the file folders or any index tabs that may be on the file folders. The lid 23 may also be delivered flat, and may be assembled using well-known fold tabs and slots 25.

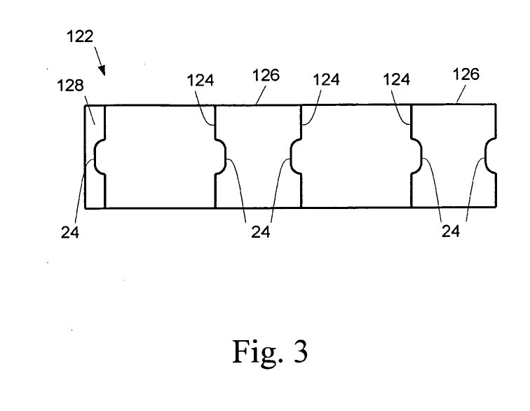

FIG. 3 shows an inner carton 122, unfolded and laid flat. The fold tabs 24 are formed from cutouts in adjacent panels of carton 122. The adjacent panels are separated by fold lines 124. Preferably, the size of the fold tabs/spacers 24 determines the spacing between the inner and outer cartons when the boxes are assembled. Preferably, the fold tabs/spacers 24 are formed by cutting into adjacent panels 124, to provide a space for the hangers on hanging folders; in FIG. 3, the hangers would hang along edges 126 (preferably covered by strips 15). When the inner box is assembled, i.e. folded at the fold lines to form a box, the tabs 24 protrude outwardly toward the inner wall of the outer box. On the sides that do not support the hangers, the spacing between inner and outer cartons is not critical, and the inner and outer cartons may be direct contact, without the need for the spacing created by the fold tabs 24. This improves the structural strength of the inner box. Note, that if the box is to be made to hang file in two directions, such as US letter and US legal, then spacers 24 must be provided on all 4 panels of the inner box. These additional spacers would be provided preferably above or below the existing spacers 24 but in the opposite direction, so that they would protrude into the panel sections from which spacers 24 presently protrude. Note that the inner carton may be sized to accommodate different sized hanging folders along opposite dimensions. For instance, one pair of opposing sides may accommodate legal-sized folders, while the other pair of opposing sides may accommodate letter-sized folders. Note that more than one fold tab/spacers 24 may be used along an edge, and it may be preferable to use one near the top in addition to one near the bottom for additional support. The inner carton has an optional panel 128, shown at the leftmost portion of FIG. 3, which may optionally be used for attaching (such as by glue) to the rightmost portion of the inner carton when assembled to make a continuous perimeter. This will enhance rigidity. The pairs of opposing sidewalls formed at fold lines to create a self supporting box shaped perimeter of sidewalls. The advantage of having a self supporting structure is that the insert will stay erect before or after the folders are inserted without collapsing. Thus the user will not have to maintain the insert in place when filling with folders. This will also make it possible to file the insert and then drop the insert into the outer box, if that is convenient. Frankly it is also possible to dispense with the outer box and use the insert as a box in its own right because it will have complete integrity without a bottom once filed with hanging files.

Alternatively, spacers could be separately inserted (or affixed to the outer surface on the inner box, or the inner surface of the outer box) to position the inner carton away from the outer carton surface on the side that receives the hooks where spacing is important. The result, therefore, is an inner box at least sidewalls which can be folded but when constructed provides a removable inner liner with rigid edges for separating the hooks of hanging files and spaces to keep the inner box central with the outer box. This solution is however not a single step set up.

The invention therefore includes a system, structure and a method. The method is directed to the retrofit of a document box by inserting a unitary inner box with self erecting spacer tabs formed when the inner box is folded into its perimeter inner liner shape. A further method is disclosed which is directed to the method of forming spacers for an inner liner by providing a plurality of fold lines and then cutting projections/tabs into the adjacent panel area to form a self supporting rectangular column or “plenum” to hold hanging folders.

The description of the invention and its applications as set forth herein is illustrative and is not intended to limit the scope of the invention. Variations and modifications of the embodiments disclosed herein are possible, and practical alternatives to and equivalents of the various elements of the embodiments would be understood to those of ordinary skill in the art upon study of this patent document. These and other variations and modifications of the embodiments disclosed herein may be made without departing from the scope and spirit of the invention.

1. A support insert for a file box used for hanging folders having end hooks comprising:
a. first and second pairs of opposing sidewalls formed at fold lines to create a self supporting box shaped perimeter of sidewalls, each sidewall having an upper edge and an outer surface, said insert being sized to be received within the inner dimension of the file box;
b. at least one of said sidewall pairs including at least one integral spacer tab extending outwardly therefrom toward the inner surface of the file box, and when inserted therein creating a spacing gap between the inner surface of the file box and the outer extent of the insert, said gap being large enough to accommodate file folder end hooks supported by said upper edge but without providing support from said file box.

2. The insert of claim 1 wherein said sidewalls are formed of a single sheet with fold lines and joined end to end to form a substantially non-collapsing structure.

3. The insert of claim 1 wherein said tab length is just greater than the extent which the hooks extend beyond the outer edge of the insert sidewalls.

4. The insert of claim 1 wherein said tab length is equal to the extent which the hooks extend beyond the outer edge of the insert sidewalls.

5. The insert of claim 1 further including a pair of substantially non-deformable protective strips applied over at least two of said upper edges, so that the hooks do not deform under the pressure of said hooks.

6. The insert of claim 5 wherein said strips include a top surface, two side surfaces defining a space for said upper surface of said sidewall, and at least one barb extending from a side surface and extending into the defined space.

7. The insert of claim 6 wherein sad barb extends into said space toward said top surface.

8. The insert of claim 1 wherein said spacer tab extends from one sidewall at a fold line and is taken from a portion of an adjacent sidewall on the opposite side of that fold line.

9. The insert of claim 1 wherein said spacer tabs extend from each of said four sidewalls so that said insert is spaced from said file box on all sides whereby hanging folders may be hung on either pair of sidewalls.

10. A file box for supporting hanging folders having end hooks comprising:
a. an outer box having four sides and a bottom and inner surfaces to said sides;
b. an insert sized to be received within said outer box; including:
i. first and second pairs of opposing sidewalls formed at fold lines to create a self supporting box shaped perimeter of sidewalls, each sidewall having an upper edge and an outer surface, said insert being sized to be received within the file box;
ii. said sidewall pairs each including at least one integral spacer tab extending outwardly therefrom toward the inner surface of the file box, and when inserted therein creating a spacing gap between the inner surface of the file box and the outer extent of the insert at each file box sidewall, said gap being large enough to accommodate file folder end hooks, so that hanging files may be supported from either pair of insert sidewalls but without the hooks being supported by said outer box.

11. A method of constructing a self supporting file box insert, for an outer file box, with an integral spacer tab to prevent hanging file hooks suspended from said insert from being supported by the outer file box, comprising the steps of:
a. cutting a sheet into a rectangular shape;
b. identifying fold lines at points along one extent to create adjacent panels;
c. cutting tab shapes into said adjacent panels at said fold lines to create extensions out of an adjacent panel;
d. folding the panels at the fold lines without folding the tabs
e. connecting first and last panels for form a self supporting rectangular column.

12. The method of claim 11 wherein said cutting step includes cutting tabs in every panel so that every panel has a portion taken from an adjacent panel thereby creating spacing tabs on every corner of the insert.

13. The method of claim 10 further including the step of making the upper surface of at least two opposing sidewalls resistant to deformation from hanging file hooks.

14. The method of claim 13 wherein said deformation resistance is formed by applying a deformation resistant edge on the upper surface.

15. The method of claim 14 wherein the deformation resistant edge includes providing a one-way barb to maintain the edge in place.
